(19) United States
(12) Patent Application Publication
(10) Pub. No.: US 2023/0021589 A1
(43) Pub. Date: Jan. 26, 2023

(54) DETERMINING EXTERNAL DISPLAY ORIENTATION USING ULTRASOUND TIME OF FLIGHT

(71) Applicant: Intel Corporation, Santa Clara, CA (US)

(72) Inventors: Xintian Lin, Palo Alto, CA (US); Matias Almada, South Lake Tahoe, CA (US); Qinghua Li, San Ramon, CA (US)

(21) Appl. No.: 17/957,816

(22) Filed: Sep. 30, 2022

(51) Int. Cl. G01S 5/26

(52) U.S. Cl. CPC G01S 5/26

(57) ABSTRACT

Apparatuses, methods and storage medium associated with identifying a physical distance using audio channels are disclosed herein. In embodiments, an apparatus may include at least one speaker and microphone associated with an audio channel, which may be of a plurality of audio channels. The apparatus may include circuitry to identify an amount of time between times of transmission of a first ultrasonic signal, and receipt of a second ultrasonic signal received via the microphone. The second ultrasonic signal may be transmitted by an external device, which also may provide a time between receipt of the first signal and transmission of the second signal. The amount of time may be usable to determine a physical distance between the apparatus and the external device. Other embodiments may be disclosed or claimed.

### TECHNICAL FIELD

The present disclosure relates to computing and more specifically relates to determining the orientation and position of an external display using ultrasound time of flight.

### BACKGROUND

Many currently available devices, including desktop computers, laptops, and mobile devices such as tablets and smartphones, are capable of driving one or more external displays, such as a monitor or HDTV. In some use scenarios, the device may drive the display via a cable, such as an HDMI or DisplayPort cable. In other use scenarios, the device may drive the display via a wireless link, such as over a WiFi connection. The position of the external display(s) may impact where a user wishes to display content, such that a user may wish to configure their device to reflect the layout of the external display(s).

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example system equipped with technology for identifying a physical distance using audio channels, according to various embodiments.

FIG. 2A illustrates the exchange of ultrasonic signals between an apparatus and a remote device to allow the apparatus to determine the range from the remote device, according to various embodiments.

FIG. 2B illustrates the exchange of ultrasonic signals between an apparatus and a remote device to allow the apparatus to determine the range from the remote device where the speaker is located between the apparatus microphone and the remote device, according to various embodiments.

FIG. 3 illustrates the exchange of multiple ultrasonic signals between two apparatuses to allow each apparatus to determine its range and orientation from the other apparatus, according to various embodiments.

FIG. 4 is a flowchart of the operations carried out by an apparatus to determine its range from a remote device, according to various embodiments.

FIG. 5 illustrates a second possible exchange of ultrasonic signals between an apparatus and a remote device to allow the apparatus to determine the range from the remote device, according to various embodiments.

FIGS. 6A-C illustrate several possible arrangements of a first device and a second device with simplified equations comparing distances to determine a position of the second device relative to the first device, according to various embodiments.

FIG. 7 is a block diagram of an example computer that can be used to implement some or all of the components of the disclosed systems and methods, according to various embodiments.

FIG. 8 is a block diagram of a computer-readable storage medium that can be used to implement some of the components of the system or methods disclosed herein, according to various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a programmable combinational logic circuit (such as a field programmable gate array (FPGA)) a processor (shared, dedicated, or group) and/or memory (shared, dedicated, or group) that execute one or more software or firmware programs, and/or other suitable components that provide the described functionality.

Configuring multiple external displays to an apparatus such as a laptop, desktop, or mobile computer device often requires significant user interaction. The user may need to manually arrange the display layout using a software tool on the apparatus, which can be time consuming and, depending upon the layout of the software tool, potentially confusing. Automatically detecting the location and orientation of one or more external devices can help simplify or even eliminate this process.

One possible detection strategy involves determining a distance and potentially an orientation of an external display from a computer device. Ranging for distance can be carried out using a variety of techniques. For example, radio signals can be used. However, radio ranging typically requires specialized equipment not normally equipped to a consumer-oriented computer device, particularly for close distances where radio time of flight is nearly instantaneous and thus difficult to accurately measure. Other ranging approaches may use infrared or laser pulses, which can be used for precise measurement of close distances. However, as with radio ranging, infrared and laser both require a computer device to be specially equipped with the necessary emitters and sensors.

Disclosed embodiments include a computer device that engages in ranging and/or orientation detection of a device such as an external display using equipment that is typically equipped to most computer devices. Specifically, embodiments utilize ultrasonic signaling. Ultrasonic signals can be emitted from a typical computer device speaker for transmission, and on-board microphones can typically detect these signals. Furthermore, most modern computer devices, including external displays, are equipped with multiple speakers and/or multiple microphones, which may be configured in an array. The use of multiple speakers with multiple microphones allows for increasing accuracy of distance measuring, and determination of orientation of the external display, e.g. portrait or landscape, and possibly angle, relative to the computer device. The external display can be any suitable display that may be useable by a computer device for displaying content, such as stand-alone monitors, device displays, smart televisions, or other devices that can display content and be equipped to a microphone and speaker for receiving and transmitting ultrasonic signals. The disclosed embodiments can be used two-way, e.g. two devices similarly equipped can exchange ultrasonic pulses with each other and determine each other's distance, angle, and relative orientation roughly simultaneously. It should be understood that, while embodiments disclosed herein may focus around external displays, the disclosed systems and techniques could be used to determine the distance, angle and/or orientation of any suitably equipped external device, such as another computer or mobile device or peripheral. Furthermore, the determined distance may also be useful for indicating signal strength when establishing a wireless connection between a computer device and an external display, e.g., determining the feasibility and possible bandwidth of a wireless display connection. For example, where available bandwidth for an acceptable viewing experience may decrease as distance increases, the determined distance may be used to signal a user that a device is at the edge or outside of a range where a reliable connection with sufficient bandwidth can be maintained.

Ultrasonic ranging can be performed unilaterally, e.g. from the computer device acting alone. The computer device may emit an ultrasonic pulse and measure the roundtrip time between emission and when an echo of the pulse is received by the computer device's microphone. However, due to the directional nature of ultrasonic signals, such an approach would require aiming the microphone in the direction of the object to be ranged. Failure to do so would likely result in a reading from an unintended object rather than an accurate range to an intended external device. Even then, depending on the configuration of the computer device's speaker, the ultrasonic signal may reflect off surrounding surfaces and result in a spurious reading.

To avoid this scenario, the external device may also be equipped with a speaker and a microphone, and configured to respond in kind when it receives an ultrasonic pulse. When so configured, the computer device can emit an undirected ultrasonic pulse, which the external device can answer without either device being oriented towards the other. However, the external device typically introduces a latency between receipt of the computer device's pulse and the external device's response, due to processing time at the external device. This latency introduces an inaccuracy in distance measuring and may prevent an accurate determination of relative device orientation. This issue can be resolved by precisely synchronizing the clocks of the external device and computer device prior to ranging and report an actual time of receipt of an ultrasonic pulse. However, clock drift will necessitate routine synchronization and/or increase processing requirements to track and compensate for the drift. Moreover, some devices, such as monitors, may not be normally equipped with a clock, making ranging that requires synchronized clocks an impossibility.

Disclosed embodiments provide for ultrasonic ranging between two or more devices that does not require the devices to have and maintain synchronized clocks. In some embodiments, a first device may transmit an audio signal through a speaker (e.g., an integrated speaker). The audio signal may be in a frequency that is inaudible to human hearing (e.g., ultrasonic sounds that are above human hearing), and as such may be referred to as an inaudible audio signal or ultrasonic signal. The audio signal via the speaker travels non-immediately (e.g., at the speed of sound) to the receiving device where the sound may be recorded via microphone(s), e.g., integrated microphone(s) of a second device.

On the receiver side, a component of an external second device coupled to one or more microphones (e.g., a codec, an Analog to Digital Convertor (ADC), or the like, or combinations thereof) may record the arriving ultrasonic or audio signal. The travel time of the acoustical path from the first device to the second device may be approximately equal to the time difference of the receipt times. This travel time (e.g., this approximation of the travel time) may be used to accurately measure the physical distance between the devices. However, as explained above, in existing solutions this time cannot be calculated precisely without synchronized clocks between the sender and receiver. To address this shortcoming, the second device, in embodiments, may also transmit an audio signal from one or more speakers upon receipt of a request to initiate the ranging process from the first device. The second device then determines an amount of time between the receipt of the audio signal from the first device and the transmission of the second device's audio signal, and then transmits the amount of time to the first device. Notably, the second device can emit its ultrasonic signal at the same time or even precede the ultrasonic signal from the first device.

As long as each device transmits and each device captures the other device's ultrasonic signal, and the devices exchange times of reception and transmission, there is enough information for each device to estimate its distance from the other device and/or the other device's relative position. This amount of time does not require a specific or synchronized clock between the two devices, as it depends on time differences calculated by the first and second devices due to the fact that it only depends on the time differences calculated by each of the first device and the second device. The ultrasound pulses transmitted by the two devices do not have to follow each other in a fixed pattern so long as they are each recorded by both devices.

In embodiments, a number of ultrasound transmitters (e.g., two or more) such as speakers may be utilized to transmit ultrasonic signals, along with a number of microphones (e.g., two or more), such as a microphone array, to receive ultrasonic signals. The locations and geometry of the speakers and/or the microphones may be known by the operating system or another service, or may be pre-programmed. Given the locations of the speakers and the microphones, multiple distances from a comparably equipped first or second device may allow an accurate estimation of the three dimensional location of the second device relative to the first device, and vice-versa, through trilateration. The greater the number of both transmitters and microphones, the more precisely the distance and orientation of one device relative to the other can be determined. This orientation may then be used by a computer device as further input, such as to a monitor configuration utility or screen casting or sharing program.

In some embodiments, the ultrasonic signals may be uniquely encoded for identification. Ultrasonic signals may be transmitted from multiple transmitters/speakers simultaneously, with variations in phase between the speakers used to distinguish the particular speaker that is the source of a particular ultrasonic signal. The amount of time calculated by an external device from receipt of the initial signal to transmission of the responding signal may be provided by a separate channel, such as via a Bluetooth or NFC transmission, in some embodiments. In other embodiments, the amount of time may be embedded within the responding signal if sufficient bandwidth can be achieved. Other possible embodiments will be discussed herein.

In some possible embodiments, ranging may be performed in a “daisy chain” fashion, where a first device determines its range to a first external monitor or device, and then the first external monitor or device determines its range and/or orientation to a second external monitor or device, and so forth. Such a configuration may be useful when establishing a connection to a display array, as only one possible example, such as a wall or bank of monitors. A computer device may only need to range to a first one of the array of monitors, with each of the monitors in turn determining orientations to one or more of the remaining monitors. The configuration may then be transmitted to the computer device, allowing the computer device to use the array without having to establish distance and orientation to each member of the array.

In still other possible embodiments, the remote display may be another computing device, as mentioned above, such as a desktop or another laptop, and the ranging and orientation may be used to allow a first device, such as a laptop, to present or otherwise use a display of a nearby second device as a secondary display. Conversely, a person may have a deskop and laptop computer, and may desire to use the laptop computer's display to extend the desktop display; the disclosed techniques may be used to determine the location and orientation of the laptop relative to the desktop to facilitate the desktop using the laptop display as a secondary monitor, provided the laptop is configured to allow its display to be used to project an external signal.

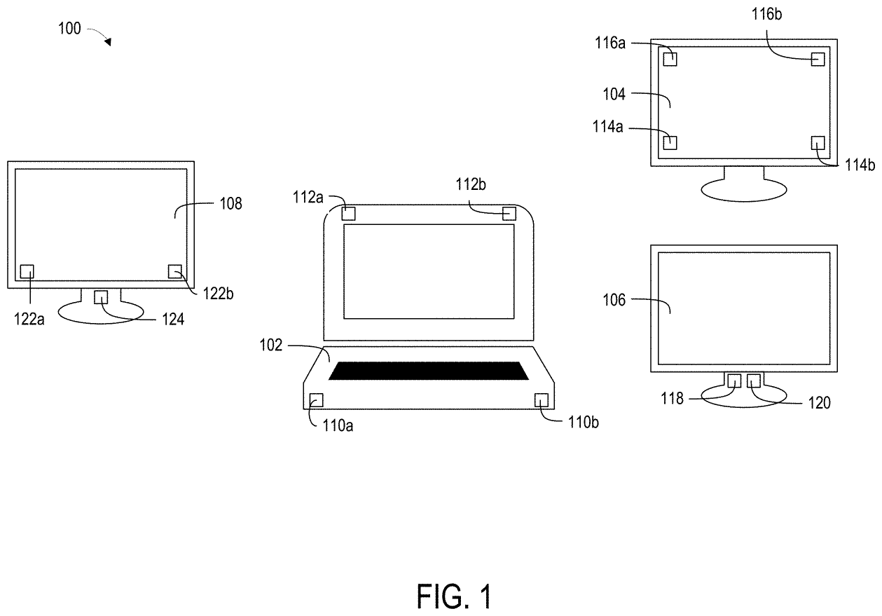

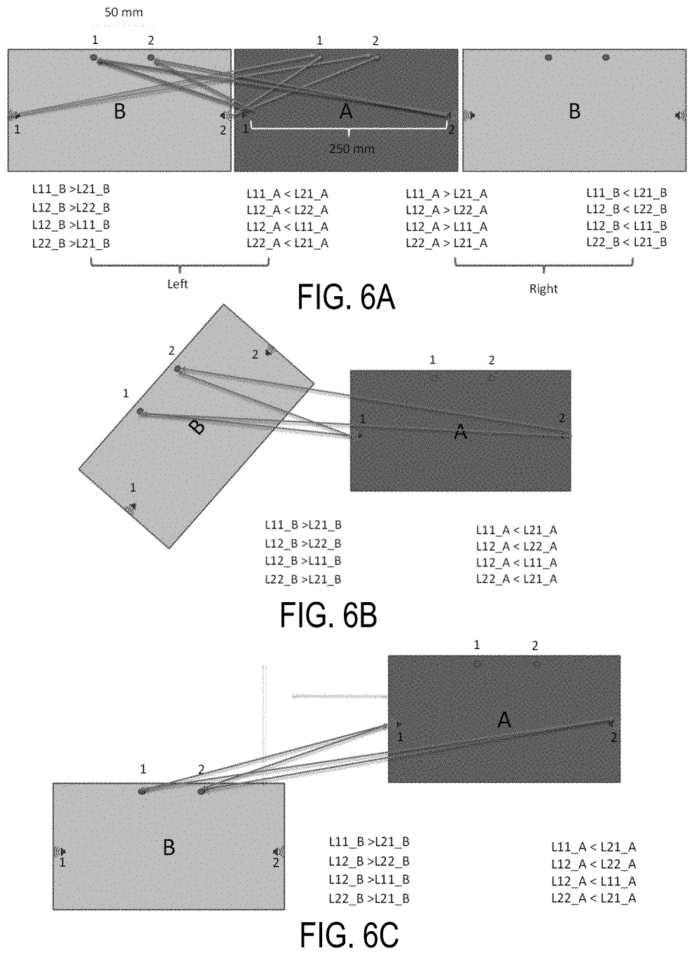

FIG. 1 illustrates an example system 100 that supports the use of ultrasonic signals for ranging and determining orientation that does not require clock synchronization between devices. System 100 includes a computer device 102 and several external devices 104, 106, and 108. In the disclosed embodiment, computer device 102 may be a computer device 1500, described herein with respect to FIG. 6, such as a laptop or desktop computer, or a mobile device. External devices 104, 106, and 108 are illustrated as monitors or televisions, although it should be understood that one or more of the external devices may be another type of device, such as a computer device, or any other type of device where determining a range and/or orientation with respect to computer device 102 is desired. Furthermore, although three external devices 104, 106, and 108 are depicted, it should be understood that this is illustrative only, and that any arbitrary number of devices may be provided, subject to practical considerations such as space.

As illustrated, computer device 102 is equipped with a speaker array which includes speakers 110a and 110b (referred to collectively as speaker array 110), and a microphone array which includes individual microphones 112a and 112b (referred to collectively as microphone array 112). The speaker array 110 and microphone array 112 may be configured to transmit and receive ultrasonic signals, respectively. In embodiments, each speaker of speaker array 110 may be able to individually transmit an ultrasonic signal that is unique from a signal transmitted by other speakers of the speaker array 110. Likewise, in embodiments, each microphone of microphone array 112 may be utilized to capture and/or record signals independently of the other microphones. Any type of speaker and/or microphone may be employed, so long as they are capable of transmitting and receiving, respectively, ultrasonic signals. In other embodiments, any type of transducer and/or audio capture device of any suitable technology that can transmit and receive ultrasonic signals, respectively, may be employed.

The external devices 104, 106, and 108 are each equipped with at least one speaker and one microphone capable of transmitting and receiving ultrasonic signals, respectively. The speakers and microphones are configured differently on each device for illustrative purposes; in some embodiments, each external device may be identically configured with the same number of speakers and microphones, and may be configured in identical geometries. External device 104 includes a speaker array 114 that includes speakers 114a and 114b, and a microphone array 116 that includes microphones 116a and 116b. As can be seen, the speaker array 114 is positioned near the base of the device 104's screen, while the microphone array 116 is positioned near the top of the device 104's screen. External device 106 includes a single speaker 120 and single microphone 118, both located proximate to the base and bottom of the screen of the external device 106. External device 108 includes a speaker array 122 consisting of speakers 122a and 122b, located proximate to the bottom of the screen of external device 108. A single microphone 124 is located proximate to the base and bottom of the screen. The various speakers and microphones may be similar to the speakers and microphones equipped to computer device 102, using any suitable technology now known or later developed that is capable of emitting or receiving ultrasonic signals.

Along with computer device 102, each of the external devices 104, 106, and 108 may be capable or otherwise adapted to receive an ultrasonic signal, emit an ultrasonic signal, and measure time between signal reception and signal transmission, and vice-versa. Furthermore, the computer device 102 and external devices 104, 106, and 108 may be in data communication with each other, such as to exchange measured time amounts. Each of the connections may be wired and/or wireless. In some embodiments, the various devices may be capable of communicating over several different communications channels, including both wired and wireless links. Depending on the specifics of a given embodiment, each of the external devices 104, 106, and/or 108 may be equipped with circuitry, discrete components, microcontrollers, microprocessors, FPGAs, ASICs, and/or another technology or combination of technologies that supports the receipt, transmission, and time measurement functions, as well as controlling any data links with computer device 102 for exchange of time information as well as signals pertinent to function, such as a display signal, audio signal, and/or another signal appropriate for a given embodiment.

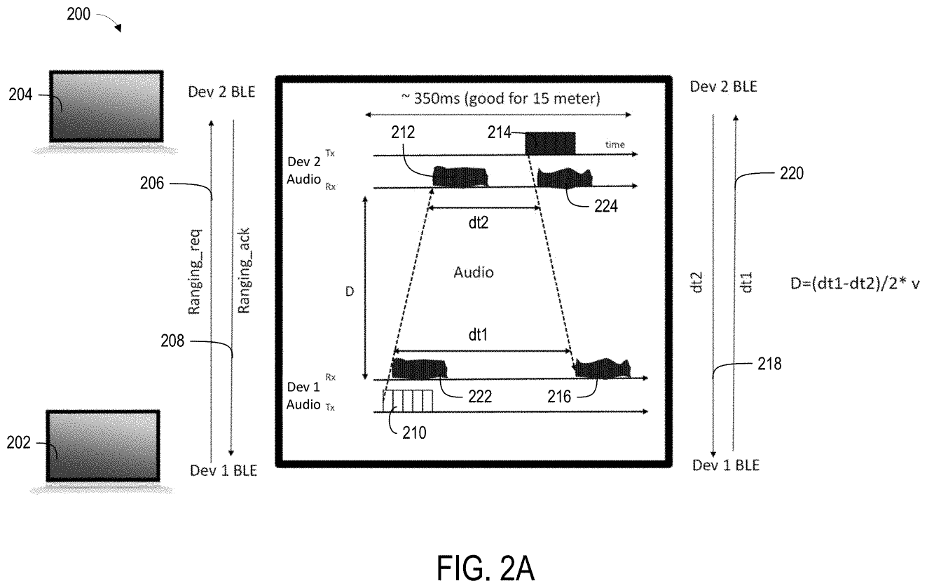

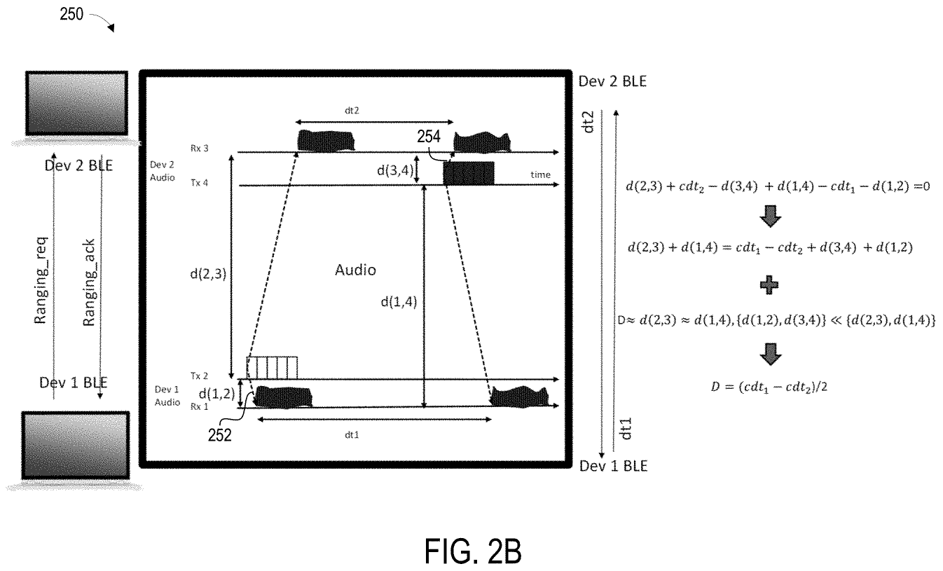

FIG. 2A illustrates a first possible exchange 200 of signals between a first device 202, which may be computer device 102, and a second device 204, which may be external device 104, 106, or 108. Exchange 200 focuses on the exchange of messaging between a single speaker and microphone equipped to each of first device 202 and second device 204. It should be understood that first and second devices 202 and 204 may be equipped with a plurality of speakers and/or a plurality of microphones, such as speaker array 110 and microphone array 112, with the single speaker and microphone being part of the speaker array and microphone array, respectively.

The exchange begins, in the depicted embodiment, with the first device 202 sending a ranging request 206 to the second device 204. The second device 204 may send a ranging acknowledgement 208 in response. The devices may exchange the request 206 and response 208 handshake over a wireless channel in some embodiments, such as Bluetooth, Bluetooth Low-Energy (BLE), WiFi, NFC, or another suitable communication channel. In other embodiments, the devices may communicate over a wired connection, such as Ethernet, DisplayPort, HDMI, USB, or another suitable technology.

Following the request-response handshake, the first device 202 emits a first ultrasonic signal 210 from one of its speakers. The signal 210 may be received 212 at the second device 204 at one of its microphones. Similarly, the second device 204 emits a second ultrasonic signal 214, which is then received 216 by first device 202 at one of its microphones. Following exchange of the ultrasonic signals 210 and 214, the second device 204 will send 218 a time dt2 to the first device 202, and first device 202 will send 220 a time dt1 to second device 204. With the times exchanged, the first device 202 and/or the second device 204 can compute their distances from each other with the equation:

D=(dt1−dt2)/2*v

where v is the speed of sound. Time dt1 may be computed by first device 202 as the difference between a timestamp of transmission of the first ultrasonic signal 210 and a timestamp of receipt 216 of the second ultrasonic signal 214. Time dt2 may be computed by second device 204 as the difference between a timestamp of receipt 212 of the first ultrasonic signal 210 and a timestamp of transmission of the second ultrasonic signal 214. The times dt1 and dt2 may be transmitted over the same wireless channel used for the request-response handshake, or may be transmitted using a different channel.

In other embodiments, rather than exchanging times, each device may transmit its respective transmission and receipt timestamps, and each device will respectively compute dt1 and dt2. In such an embodiment, first device 202 may transmit the timestamp of transmission of the first ultrasonic signal 210 and the timestamp of receiving 216 of the second ultrasonic signal 214, and second device 204 may transmit the timestamp of transmission of the second ultrasonic signal 214 and the timestamp of receiving 212 of the first ultrasonic signal 210. With this exchange of timestamps, each device can compute dt1 and dt2. It will be understood that the first device 202 and the second device 204 do not need to have synchronized clocks, as dt1 is computed as a difference between timestamps that entirely originate with the first device 202, and dt2 is computed as a difference between timestamps that entirely originate with the second device 204.

For determination of time dt1, the timestamp of transmission of the first ultrasonic signal 210 can be recorded starting either from the point at which the signal 210 is broadcast from the speaker of the first device 202, or when the microphone of first device 202 receives 222 the transmission as it travels out from first device 202 to second device 204. For determination of time dt2, the timestamp of transmission of the second ultrasonic signal 214 can be recorded starting either from the point at which it is broadcast from the speaker of the second device 204, or when the microphone of second device 204 receives 224 the transmission as it travels out from second device 204 to first device 202.

The choice of point at which the timestamp of transmission of the first ultrasonic signal 210 is recorded for purposes of determining dt1 and/or the choice of point at which the timestamp transmission of the second ultrasonic signal 214 is recorded for purposes of determining dt2 will depend on the needs of a particular implementation. For example, in some embodiments, using the timestamp of when a device records its own transmission may result in more accurate distance measurements due to timing uncertainties from the delay between when an audio signal is sent for transmission and when the device's speaker actually transmits the signal. In other embodiments, timestamps of both transmission from a device's speaker and subsequent receipt at the device's microphone may be used, as will be discussed below.

The calculations described above apply equally if the relationship is reversed, viz. we view FIG. 2A from the perspective of the second device 204, with second device 204 calculating D. It will be understood by a person skilled in the art that times dt1 and dt2 are considered from the perspective of the device making the distance calculations. Thus, with respect FIG. 2A, dt1 and dt2 are reversed when the second device 204 is computing the distance D using the equation described above from timestamps. From the perspective of second device 204, dt1 is computed by subtracting the timestamp of its transmission of second signal 214 from the timestamp of the reception 212 of the first signal 210, and dt2 is computed by subtracting the timestamp of receipt 216 of the second signal from the timestamp of the transmission of the first signal 210. As the second signal 214 was transmitted after receiving 212 the first signal 210 and so would be later, and the second signal 214 was received 216 after the transmission of the first signal 210 and so would be later, both dt1 and dt2 will be negative values. However, it will be appreciated that this arrangement still results in a positive D. As dt2 in the arrangement from the perspective of second device 204 is greater than dt1 owing to the reversal of the numerator of the equation, a negative dt1 is subtracted from a negative but larger dt2, still resulting in a positive time delta value (e.g., −dt1−(−dt2)). Thus, a person skilled in the art will recognize that the second device 204 computes the same value for D as computed by first device 202, and without the need for the first device 202 and the second device 204 to have synchronized clocks.

It will be recognized by a person skilled in the art that the foregoing discussion with respect to FIG. 2A assumes that the transmitting speaker of the first device 202 is located more distal from the second device 204 than the microphone of first device 202, and substantially in line with the microphone of the first device 202. Thus, a reasonably accurate distance can be ascertained between the first device 202 and second device 204 while ignoring the impact of any angular relationship between the speaker and the microphones. An example of these angular relationships between microphone and speaker placement can be seen in FIG. 6A. However, where the speaker of the first device 202 is located between the second device 204 and the microphone of first device 202, viz. the microphone of the first device 202 is more distal from the second device 204 than the speaker of the first device 202, the distance between the speaker and the microphone of the first device 202 must be accounted for to obtain a reasonably accurate distance measurement.

FIG. 2B illustrates an example exchange 250 of signals where the speaker of the first device 202 is closer to second device 204 than the microphone of the first device 202, and the equations that take this arrangement into account to obtain an accurate distance. The components of exchange 250 are identical to those of exchange 200 (FIG. 2A) and the same callouts apply, except for the addition of a distance pair d(1,2) that represents the distance 252 between the speaker and the microphone of first device 202, and a distance pair d(3,4) that represents the distance 254 between the speaker and microphone of second device 204. The equation for computing the distances that accounts for the distances 252 and 254 may be as follows:

d(2,3)+cdt₂−d(3,4)+d(1,4)−cdt₁−d(1,2)=0

The distance pairs d(1,2) and d(3,4), corresponding to the speaker to microphone distances for first device 202 and second device 204, respectively, can be known in advance either as fixed distances, or provided by each device's operating system. These terms may be rearranged, as follows:

d(2,3)+d(1,4)=cdt₁−cdt₂+d(3,4)+d(1,2)

Thus, when each speaker is located between its device's corresponding microphone and the microphone of the remote device, the local speaker to microphone distance, that is, distances 252 (d(1,2)) and 254 (d(3,4)), are added to the distances calculated from the times dt1 and dt2 to obtain a more accurate distance estimate. This is necessary because the times dt1 and dt2, as can be seen in FIG. 2B, are calculated as the time difference when each respective device receives its local transmission and the remote device transmission.

In the discussion below, exchange 200 will be referred to at various points. It should be understood that exchange 250 and the foregoing description can be substituted for exchange 200 any time the arrangement of microphone(s) and speaker(s) so requires.

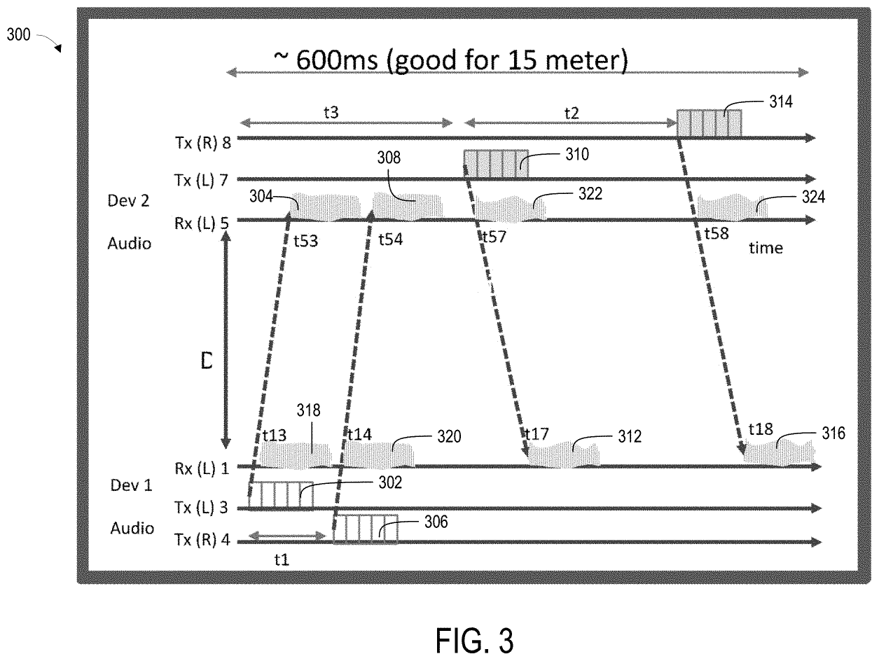

FIG. 3 illustrates the exchange 300 of ultrasonic signals across multiple speakers between a first device and a second device. The use of multiple speakers and/or multiple microphones can allow the calculation of multiple distances from multiple locations on the first and second devices, which can allow for more precise estimation of distance as well as computation of the spatial orientation of the devices relative to each other, e.g. rotation, angle, altitude, etc.; essentially, calculation of up to six degrees of freedom (x, y, z positioning and roll, pitch, and yaw angles of orientation). The process of exchange 300 is otherwise identical to exchange 200, described above; the request-response handshake and exchange of times/timestamps are not illustrated. The reader is referred to the description of FIGS. 2A and 2B above for details.

Exchange 300, in the depicted embodiment, includes transmission of a first ultrasonic signal 302 from a first speaker Tx(L)3 and a second ultrasonic signal 306 from a second speaker Tx(R)4 from the first device, which are respectively received 304 and 308 of the microphone of the second device. Likewise, the second device transmits a third ultrasonic signal 310 from speaker Tx(L)7,and transmits a fourth ultrasonic signal 314 from speaker Tx(R)8. The third and fourth ultrasonic signals 310 and 314 are correspondingly received 312 and 316 at the first device. These four ultrasonic signals can thus result in the following set of equations to determine round-trip distances:

d(3,5)−d(3,1)+d(7,1)−d(7,5)=((t17−t13)−(t57−t53))*c

d(4,5)−d(4,1)+d(7,1)−d(7,5)=((t17−t14)−(t57−t54))*c

d(3,5)−d(3,1)+d(8,1)−d(8,5)=((t18−t13)−(t58−t53))*c

d(4,5)−d(4,1)+d(8,1)−d(8,5)=((t18−t14)−(t58−t54))*c

where c is the speed of sound. Each distance pair of d(x,y) is defined as the distance between a transmission point and reception point. Thus, d(3,5) is the distance between Tx(L)3,the left speaker of the first device, to the Rx(L)5 microphone of the second device; d(3,1) is the distance between Tx(L)3 and Rx(L)1, the microphone of the first device; d(7,1) is the distance between Tx(L)7, the left speaker of the second device, to the Rx(L)1 microphone of the first device; d(7,5) is the distance between Tx(L)7 and Rx(L)5; d(4,5) is the distance between Tx(R)4, the right speaker of the first device, to the microphone of the second device; d(4,1) is the distance between Tx(R)4 and Rx(L)1; d(8,1) is the distance between Tx(R)8, the right speaker of the second device, to the microphone of the first device; and d(8,5) is the distance between Tx(R)8 and Rx(L)5. The various timestamps, t13, t14, t57, and t58 correspond to the transmission timestamps of the first, second, third, and fourth ultrasonic signals 302, 308, 310, and 314, respectively, while t53, t54, t17, and t18, correspond to the timestamps of reception 304, 308, 312, and 316, respectively of the associated ultrasonic signals. Thus, t17−t13, for example, would correspond to the elapsed time between the timestamp of when the first device transmits (t13) the first ultrasonic signal 302 and the timestamp of when the first device receives 312 (t17) the second ultrasonic signal 310 from the second device, and t57−t53 would correspond to the elapsed time between the timestamp of when the second device receives 304 (t53) the first ultrasonic signal 302 and the timestamp of when the second device transmits (t57) the second ultrasonic signal 310.

A person skilled in the art will recognize from the foregoing that each of the equations is essentially an instance of the exchange 200 described in FIG. 2A. Each equation is a permutation derived from each combination of one of the transmitted ultrasonic signals from the first device that is received at the second device, and one of the transmitted ultrasonic signals from the second device that is transmitted in response. Furthermore, for simplicity FIG. 3 only illustrates a single microphone (the left side) on each of the first and second devices. The first and second device may each have a second microphone for a right channel, e.g. a stereo pair. Receipt of the signals at the right channel of the first device would result in four additional equations:

d(3,5)−d(3,2)+d(7,2)−d(7,5)=((t27−t23)−(t57−t53))*c

d(4,5)−d(4,2)+d(7,2)−d(7,5)=((t27−t24)−(t57−t54))*c

d(3,5)−d(3,2)+d(8,2)−d(8,5)=((t28−t23)−(t58−t53))*c

d(4,5)−d(4,2)+d(8,2)−d(8,5)=((t28−t24)−(t58−t54))*c

The number 2 in the set of equations for the distance pairs and times would correspond to a right microphone Rx(R)2 on the first device. Similarly, the second device may have a right microphone, which would be labeled Rx(R)6, which would result in eight additional equations from receipt of the transmitted ultrasonic signals of the first device at the right microphone of the second device, and receipt of the transmitted ultrasonic signals of the second device at the right and left microphones of the first device. In other words, eight additional equations in the pattern of the above example equations can be derived by replacing index 5 with index 6 in all variables:

d(3,6)−d(3,1)+d(7,1)−d(7,6)=((t17−t13)−(t67−t63))*c

d(4,6)−d(4,1)+d(7,1)−d(7,6)=((t17−t14)−(t67−t64))*c

d(3,6)−d(3,1)+d(8,1)−d(8,6)=((t18−t13)−(t68−t63))*c

d(4,6)−d(4,1)+d(8,1)−d(8,6)=((t18−t14)−(t68−t64))*c

d(3,6)−d(3,2)+d(7,2)−d(7,6)=((t27−t23)−(t67−t63))*c

d(4,6)−d(4,2)+d(7,2)−d(7,6)=((t27−t24)−(t67−t64))*c

d(3,6)−d(3,2)+d(8,2)−d(8,6)=((t28−t23)−(t68−t63))*c

d(4,6)−d(4,2)+d(8,2)−d(8,6)=((t28−t24)−(t68−t64))*c

A person skilled in the art would readily understand these additional permutations.

As explained above with respect to FIG. 2A and exchange 200, the various transmission times t13, t14, t57, and t58 of the first, second, third, and fourth ultrasonic signals 302, 306, 310, and 314, respectively, may be determined with either the timestamp of transmission from their respective speakers, or the timestamp of when the microphones on the associated devices receive the transmissions. The choice of which time point to use may depend upon the needs of a specific implementation. In the disclosed embodiments, the timestamp(s) of when each device's microphone(s) record(s) its transmission(s) may be used to avoid potential inaccuracies resulting from delays imposed by the speaker path from when a signal is queued for transmission that are inherent in most computer devices. These delays can make obtaining a timestamp that accurately reflects actual signal transmission problematic, if not impossible. Similar to exchange 200, these receipt times include time 318 (t13) for receipt of first ultrasonic signal 302, time 320 (t14) for receipt of second ultrasonic signal 306, time 322 (t57) for receipt of third ultrasonic signal 310, and time 324 (t58) for receipt of fourth ultrasonic signal 314. It will be understood by a person skilled in the art that additional times would be possible with respect to the second microphones on each of the first and second devices.

Still further, in some other embodiments, timestamps of both the actual transmission time (if it can be ascertained with relative precision) as well as the various receipt times may each be utilized to create further permutations supporting additional equations, as differing positions of each speaker and each microphone will yield slightly different distance calculations. In most embodiments, increasing the number of equations will increase the overall accuracy of the range and orientation determinations. Still further, it should be understood that first and/or second device may have more than two speakers and/or more than two microphones. Additional devices can result in still further permutations and equations to solve; likewise, fewer devices will result in fewer permutations and equations. As with the exchange 200 of FIG. 2A, the order in which the various ultrasonic signals are transmitted may vary from the example illustrated in exchange 300, with the second device transmitting one or more ultrasonic signals before the first device, and vice-versa. So long as the devices exchange signals and timestamps for receipt and transmission, the order does not matter for computing accurate distances.

While exchange 300 has the first device initiate the second ultrasonic signal 306 after the first ultrasonic signal 302, in some embodiments, the signals can be sent simultaneously, as each signal is transmitted from its own speaker. Simultaneous transmission can reduce the total transmission time (and thus time to complete the ranging) and/or can boost the sounding power. Simultaneous transmission may require an encoding scheme to be applied to the ultrasonic signals to ensure each can be deciphered. For example, the P-matrix used by 802.11n/ac/ax/be multi-antenna channel training can be used for the encoding. For two speakers, the two speakers send the same sounding symbol with the same phase simultaneously as the first sounding symbol, and then the two speakers send the same sounding symbol with opposite phases simultaneously as the second sounding symbol. Compared with the time-sharing transmissions depicted in exchange 300, the speakers are on during the two sounding symbols instead of only one. Therefore, the transmission power is higher than the time-sharing scheme. The encoding can be across the speakers of one device or the speakers of multiple devices. If the encoding is across multiple devices, a rough time synchronization may be needed so that all the speakers can send the sounding symbols roughly simultaneously, e.g., within cyclic prefix guard interval or zero-padding guard interval or other guard intervals. Namely, the sounding symbol boundaries of each speaker are aligned within the tolerance.

Any component of the first and/or second device may identify an amount of time between the times of transmission and receipt as described above with respect to exchanges 200 and 300, and/or calculate a physical distance between a portion of the first device and a portion of the second device based on the amount of time. In some embodiments, the computer device, such as computer device 102 (FIG. 1) may perform the calculation of the physical distance based on the amount of time. In other embodiments, the computer device may include an interface (not shown) to send a communication specifying the times, e.g. dt1 and dt2 of exchange 200 and/or additional times or time marks, to a remote device (not shown, of the system 100 or a system coupled to system 100), which may perform the various calculations of the different equation permutations.

As will be understood, the calculated physical distances may be between a transmitting speaker and a receiving microphone, or between a receiving microphone on the transmitting device and a receiving microphone on the receiving device, depending on which timestamps are employed, as discussed above. This distance can be used further used to calculate the distance between any other points on the transmission device or the reception device using information about a shape and/or dimensions of the transmission device and/or the reception device and/or a placement of the speaker and/or the microphone. These various geometries may be available via operating system interface, which may store the geometry information of an equipped speaker array, such as speaker array 110 (FIG. 1) and/or a microphone array, such as microphone array 112 (FIG. 1). Furthermore, the operating system may also provide other relevant geometric information, such as the hinge position where the computer device 102 is a laptop. The angle of the hinge may alter the geometry of the array where components are split between the base and the display, e.g. several microphones may be in the base with additional microphones in the display. Knowledge of the geometry of the speaker array, microphone array, and any device hinge, along with knowledge of the dimensions of the computer device, may allow distances and orientations to be computed with respect to nearly any point on the computer device, such as via trilateration. Still further, with this knowledge, a rotation and/or other spatial orientation of an external device may be determined relative to the computer device, e.g. whether an external display is in portrait or landscape mode, whether it is angled relative to the computer device, etc.

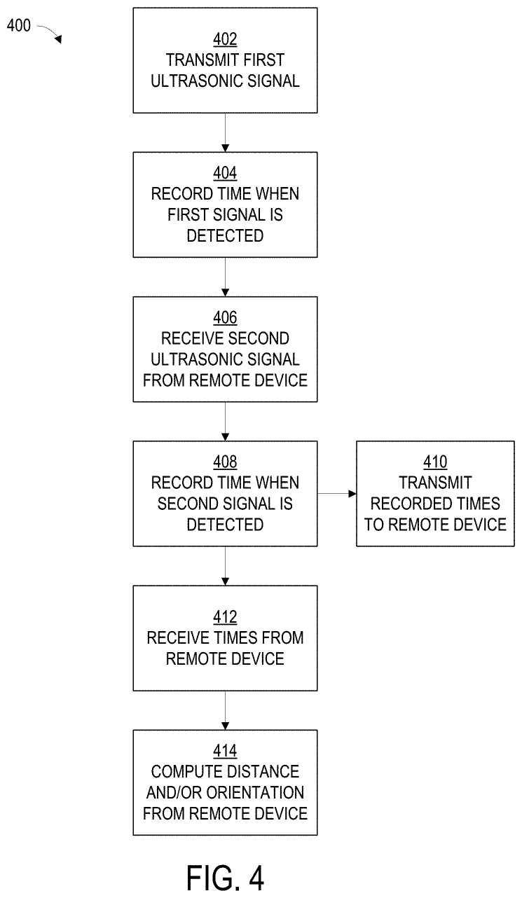

FIG. 4 is a flowchart of the various operations of a method 400 that may be carried out by a computer device, such as computer device 102, following transmission and acknowledgment of a ranging request between the computer device and a remote device. The various operations may be carried out in whole or in part, additional operations may be inserted or deleted, and operations may be carried out apart from the depicted order, depending upon the embodiment. The operations may be implemented as part of software to be executed on the computer device. While the operations of method 400 reflect the single exchange depicted in exchange 200 (FIG. 2A), it should be understood that the operations may be repeated at least in part in various iterations to facilitate multiple exchanges, similar to exchange 300 (FIG. 3). It should be understood that both the computer device and the remote device may carry out method 400, and may do so approximately contemporaneously.

In operation 402, the computer device transmits a first ultrasonic signal, such as from a speaker. The signal may, in some embodiments, be encoded with a unique pattern so that it may be more readily identified in an environment where multiple devices may be attempting ultrasonic ranging operations.

In operation 404, a timer is started or a timestamp is recorded. As described above with respect to exchanges 200 and 300, the time may be recorded upon transmission from operation 402, or may be recorded when a microphone equipped to the computer device receives or detects the transmission from the speaker.

In operation 406, a second ultrasonic signal is received at the microphone, having been transmitted from the remote device, which may be an external device such as device 104, 106, or 108. Where the signal is coded, the computer device may confirm that the code matches the expected code, to ensure that the received signal was transmitted by the external device in response to the transmission of the first ultrasonic signal, and not in response to a different device requesting a ranging operation.

In operation 408, the timer is stopped or a second timestamp is recorded upon receipt of the second ultrasonic signal, and in the sidebranch operation 410, the times recorded in operations 404 and 408 may be transmitted to the remote device.

In operation 412, a time measurement or set of timestamps is received from the external device reflecting the time elapsed between the external device's receipt of the first ultrasonic signal and transmission of the second ultrasonic signal. In some embodiments, the time measurement may be received as part of or encoded into the second ultrasonic signal, provided the signal format provides sufficient bandwidth to transmit the necessary data.

Finally, in operation 414, the elapsed time between the time recorded in operation 404 and the time recorded in operation 408 (or the recorded elapsed time if a timer is utilized), and the received time measurement or timestamps from the external device are used to compute the distance between the computer device and the external device. As discussed above, the computer device may combine multiple measurements and information about the geometry of the speakers, microphones, and/or device to determine not only a distance, but also an orientation of the external device relative to the computer device.

Both the computer device and external device may carry out one or more operations of both methods 400 and 500, with each device determining distances from the other device. Thus, each device may act as both the computer device and external device, performing methods 400 and 500 as essentially mirrors of each other.

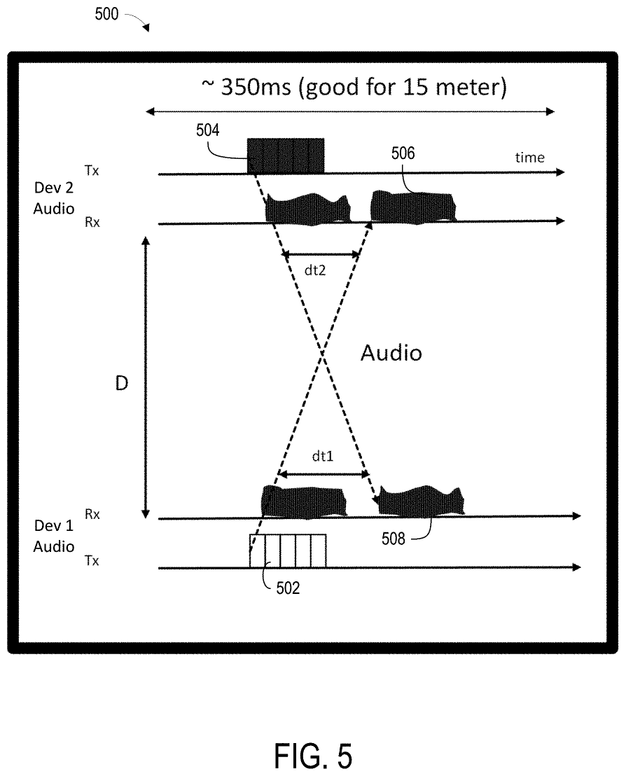

FIG. 5 illustrates a further possible embodiment of a signal exchange 500 where a first device and a second device both transmit their respective ultrasonic signals prior to receiving the ultrasonic signal from the other device. In the illustrated embodiment, a first device (not shown) transmits a first ultrasonic signal 502 and a second device (not shown) transmits a second ultrasonic signal 504. The first and second signals 502 and 504, as can be seen, are each transmitted before their respective devices receive the signal from their counterpart, viz. the second device transmits the second ultrasonic signal 504 prior to its receipt of the first ultrasonic signal 502, and vice-versa. The second device subsequently receives 506 the first ultrasonic signal 502, and the first device subsequently receives 508 the second ultrasonic signal 504. The exchange of timestamps or elapsed times is carried out the same as discussed in FIG. 2A above, and so is not illustreated here.

As will be understood, each device will still calculate identical distances D using the equation discussed with reference to FIG. 2A, above. From the perspective of the first device, time dt1 is calculated by subtracting the timestamp of the transmission of the first ultrasonic signal 502 from the timestamp of receipt 508 of the second ultrasonic signal 504. Likewise, dt2 is calculated by the first device by subtracting the timestamp of receipt 506 of the first ultrasonic signal 502 from the timestamp of the transmission of the second ultrasonic signal 504, the timestamps having been received from the second device. It will be understood that, because the timestamp of receipt 506 comes later than the timestamp of transmission of the second ultrasonic signal 504, the time dt2 will be computed as a negative number. Thus, (dt1−dt2 ) will effectively result in dt2 being added to dt1, because of subtraction of a negative number, and a correct positive computation of D using the equation discussed in FIG. 2A will result. As will be understood by a person skilled in the relevant art, performing the calculations from the perspective of the second device would result in an identical quantity for D, as discussed in connection with FIG. 2A above.

FIGS. 6A-6C illustrate a simplified application of the foregoing discussed techniques that can be used where only the relative location of a device, e.g. left or right, needs to be determined, and calculating an orientation angle is unnecessary. For example, determining a monitor layout typically only requires ascertaining whether a particular display is to the left or right; the specific angle of the display is usually immaterial. Specifically, by employing at least two speakers on a first device A, each at a different location, the device A can determine whether a second device B is located to the left or right of device A by comparing the computed distances between a first speaker and device B, and a second speaker and device B. The distances can be computed as outlined above in the discussion of FIGS. 2 and 3. In the scenarios depicted in FIGS. 6A-6C, each of device A and device B is equipped with left and right (stereo) microphones and speakers. As discussed above with respect to FIG. 3, each device having multiple microphones and speakers allows for a more certain determination of position.

FIG. 6A illustrates a first possible scenario where a device B can be located either to the left or right of device A. Device A can thus determine on which side device B is located by comparing the set of distances calculated between each of the microphones and each of the speakers. With two speakers and two microphones on each of device A and device B, each device can calculate four possible distances. Device A, for example, would compute distances L11_A, from the first (left) speaker of device A to the first (left) microphone of device B; L12_A, from the first speaker of device A to the second (right) microphone of device B; L21_A, from the second (right) speaker of device A to the first microphone of device B; and L22_A, from the second speaker of device A to the second microphone of device B. Device B would compute corresponding distances L11_B, L12_B, L21_B, and L22_B, as will be understood. With these four distances, device A and device B can determine their relative position—left or right—to each other; no angles or rotations would need to be computed. The left or right position can be determined by comparing a given device's computed distances with each other. For example, the following set of equations would indicate that device B is to the left of device A, if true:

L11_A<L21_A

L12_A<L22_A

L12_A<L11_A

L22_A<L21_A

As can be seen in the depicted arrangement, when device B is to the left of device A, the shortest path is between the left speaker of device A and the right microphone of device B (L12_A), and the longest path is between the right speaker of device A and the left microphone of device A (L21_A). Substituting the distances computed by device A for the distances computed by device B yields the same comparisons, although with the less than sign (<) changed to a greater than sign (>), reflecting the fact that from device B's perspective, device A is to the right. Were device B located to the right of device A, the comparison signs would be flipped, as a person skilled in the art will readily understand.

FIG. 6B and FIG. 6C illustrate that the foregoing arrangement and comparisons hold true regardless of whether device B is rotated relative to device A, or shifted vertically relative to device A. Given the arrangement of the microphones of device B, the one exception would be if device B is oriented perpendicular to device A, so that device B's microphones are equidistant from each speaker of device A. In such an arrangement, the values L11_A and L12_A (the distances between the device A's left microphone and device B's left and right microphones, respectively) would be roughly equal, and the values L21_A and L22_A (the distances between device A's right microphone and device B's microphones) would be roughly equal. However, device A could nevertheless still determine that device B is located to its left, albeit using only the two remaining comparisons of distances between device A's speakers:

L11_A<L21_A

L12_A<L22_A

It is worth noting that the previous inequality can be obtained by comparing the timestamp of ultrasound pulse arrivals on each device. It is not necessary to explicitly calculate the distances, which makes it easy to detect the left/right position. For example, the inequality:

L11_A<L21_A

can be determined by the arrival timestamp of device B's left speaker ultrasound pulse at device A's left and right microphones.

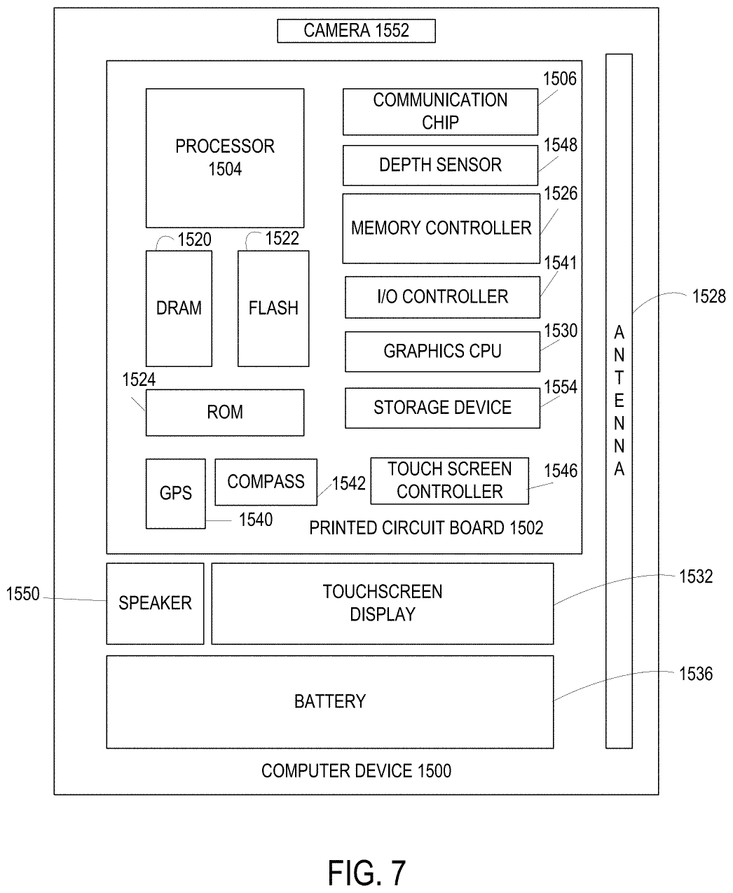

FIG. 7 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of exchange 200, exchange 250, exchange 300, method 400, exchange 500, and/or exchange 600 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

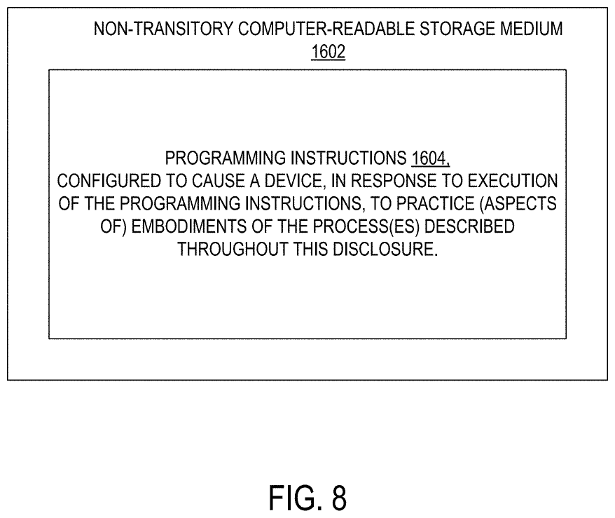

FIG. 8 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) exchange 200, exchange 250, exchange 300, method 400, exchange 500, and/or exchange 600 described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

### EXAMPLES

The following examples pertain to further embodiments.

Example 1 is an apparatus, comprising a speaker adapted to emit ultrasonic soundwaves; a microphone; and circuitry to measure a time difference between a first time and a second time, wherein the first time is an elapsed time between transmission of a first ultrasonic signal by the apparatus and a receipt of a second ultrasonic signal by the microphone, the first ultrasonic signal emitted by the speaker and the second ultrasonic signal received from an external device, and the second time is received from the external device and is an elapsed time between receipt of the first ultrasonic signal at the external device and transmission of the second ultrasonic signal; and calculate a distance between the apparatus and the external device based on the difference between the first time and the second time.

Example 2 includes the subject matter of example 1, or some other example herein, wherein the circuitry is to calculate the first time from when the first ultrasonic signal is emitted by the speaker.

Example 3 includes the subject matter of example 1, or some other example herein, wherein the circuitry is to calculate the first time from when the first ultrasonic signal is received by the microphone.

Example 4 includes the subject matter of any of examples 1-3, or some other example herein, wherein the speaker is a first speaker and the distance is a first distance, and further comprising a second speaker, and wherein the circuitry is to measure a time difference between a third time and a fourth time, where the third time is an elapsed time between transmission of a third ultrasonic signal by the apparatus and a receipt of a fourth ultrasonic signal by the microphone, the third ultrasonic signal emitted by the second speaker and the fourth ultrasonic signal received from an external device, and the fourth time is received from the external device and is an elapsed time between receipt of the third ultrasonic signal at the external device and transmission of the fourth ultrasonic signal; and calculate a second distance between the apparatus and the external device based on the difference between the third time and the fourth time.

Example 5 includes the subject matter of example 4, or some other example herein, wherein the circuitry is to calculate a third distance between the apparatus and the external device based on the difference between the first time and the third time; a fourth distance between the apparatus and the external device based on the difference between the second time and the third time; a fifth distance between the apparatus and the external device based on the difference between the first time and the fourth time; and a sixth distance between the apparatus and the external device based on the difference between the second time and the fourth time.

Example 6 includes the subject matter of any of examples 1-5, or some other example herein, wherein the circuitry is to calculate a rotation angle of the external device relative to the apparatus.

Example 7 includes the subject matter of example 6, or some other example herein, wherein the microphone is one of a plurality of microphones equipped to the apparatus, and wherein the circuitry is to calculate the rotation angle based in part on a geometry of the plurality of microphones, and first and second speakers.

Example 8 includes the subject matter of any of examples 1-7, or some other example herein, wherein the apparatus receives the second time from the external device over a wireless transmission.

Example 9 includes the subject matter of any of examples 1-7, or some other example herein, wherein the apparatus receives the second time from the external device encoded in the second ultrasonic signal.

Example 10 includes the subject matter of any of examples 1-9, or some other example herein, wherein the second time is received as a first timestamp and a second timestamp from the external device, the first timestamp corresponding to receipt of the first ultrasonic signal at the external device and the second timestamp corresponding to transmission of the second ultrasonic signal, and the circuitry is to compute the second time from the first timestamp and second timestamp.

Example 11 includes the subject matter of any of examples 1-10, or some other example herein, wherein the apparatus is a laptop computer or mobile computing device.

Example 12 is a method, comprising transmitting, from an apparatus, a first ultrasonic signal; receiving, at the apparatus, a second ultrasonic signal from a remote device; calculating, by the apparatus, a first time from transmission of the first ultrasonic signal to receipt of the second ultrasonic signal; receiving, at the apparatus, a second time from the remote device that corresponds to a time between receipt of the first ultrasonic signal and transmission of the second ultrasonic signal; and calculating, by the apparatus, a distance from the apparatus to the remote device from the first time and the second time.

Example 13 includes the subject matter of example 12, or some other example herein, wherein the second ultrasonic signal is received at a microphone equipped to the apparatus, and calculating the first time comprises calculating the time between receipt of the first ultrasonic signal at the microphone and receipt of the second ultrasonic signal.

Example 14 includes the subject matter of example 12, or some other example herein, wherein the first ultrasonic signal is transmitted from a speaker equipped to the apparatus, and calculating the first time comprises calculating the time between transmission of the first ultrasonic signal from the speaker and receipt of the second ultrasonic signal at a microphone equipped to the apparatus.

Example 15 includes the subject matter of any of examples 12-14, or some other example herein, wherein receiving the second time from the remote device comprises receiving the second time over a wireless data link.

Example 16 includes the subject matter of any of examples 12-14, or some other example herein, wherein receiving the second time from the remote device comprises receiving the second time as part of the second ultrasonic signal.

Example 17 includes the subject matter of any of examples 12-16, or some other example herein, wherein the distance is a first distance, and comprising transmitting, from the apparatus, a third ultrasonic signal, the third ultrasonic signal transmitted from a location on the apparatus that is different than a location of transmission of the first ultrasonic signal; receiving, at the apparatus, a fourth ultrasonic signal; calculating, by the apparatus, a third time from transmission of the third ultrasonic signal to receipt of the fourth ultrasonic signal; receiving, at the apparatus, a fourth time from the remote device that corresponds to a time between receipt of the third ultrasonic signal and transmission of the fourth ultrasonic signal; calculating, at the apparatus, a second distance from the apparatus to the remote device from the third time and the fourth time; and calculating, at the apparatus, an orientation of the remove device relative to the apparatus from at least the difference between the first distance and second distance, and geometry of the locations of transmission of the first and third ultrasonic signals.

Example 18 is a non-transitory computer-readable medium (CRM) comprising instructions that, when executed by a processor of an apparatus, cause the apparatus to transmit a first ultrasonic signal; receive a second ultrasonic signal from a remote device; calculate a first time from transmission of the first ultrasonic signal to receipt of the second ultrasonic signal; receive a second time from the remote device that corresponds to a time between receipt of the first ultrasonic signal and transmission of the second ultrasonic signal; and calculate a distance from the apparatus to the remote device from the first time and the second time.

Example 19 includes the subject matter of example 18, or some other example herein, wherein the instructions are to further cause the apparatus to transmit a third ultrasonic signal, the third ultrasonic signal transmitted from a location on the apparatus that is different than a location of transmission of the first ultrasonic signal; receive a fourth ultrasonic signal; calculate a third time from transmission of the third ultrasonic signal to receipt of the fourth ultrasonic signal; receive a fourth time from the remote device that corresponds to a time between receipt of the third ultrasonic signal and transmission of the fourth ultrasonic signal; calculate a second distance from the apparatus to the remote device from the third time and the fourth time; and calculate an orientation of the remove device relative to the apparatus from at least the difference between the first distance and second distance, and geometry of the locations of transmission of the first and third ultrasonic signals.

Example 20 includes the subject matter of example 19, or some other example herein, wherein the instructions are to further cause the apparatus to receive a fifth signal from the remote device; transmit a sixth signal; calculate a fifth time from receipt of the fifth signal to transmission of the sixth signal; and transmit the fifth time.

Example 21 is a method, comprising receiving, at an apparatus, an ultrasonic signal from a remote device at a first microphone; receiving, at the apparatus, the ultrasonic signal from the remote device at a second microphone; comparing, by the apparatus, a first timestamp of receipt of the ultrasonic signal at the first microphone with a second timestamp of receipt of the ultrasonic signal at the second microphone; and determining, by the apparatus, a position of the remote device relative to the apparatus based on the first and second timestamps.

Example 22 includes the subject matter of example 21, or some other example herein, wherein the ultrasonic signal is a first ultrasonic signal, and further comprising transmitting, by the apparatus, a second ultrasonic signal; receiving, at the apparatus, a first time from the remote device that corresponds to a time between receipt of the second ultrasonic signal at the remote device and transmission of the first ultrasonic signal by the remote device; and calculating, by the apparatus, a distance from the apparatus to the remote device from the difference between the first timestamp and second timestamp, and the first time.

Example 23 includes the subject matter of example 21 or 22, or some other example herein, wherein the apparatus is a laptop or mobile device.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus, comprising:
a speaker adapted to emit ultrasonic soundwaves;
a microphone; and
circuitry to:
measure a time difference between a first time and a second time, wherein:
the first time is an elapsed time between transmission of a first ultrasonic signal by the apparatus and a receipt of a second ultrasonic signal by the microphone, the first ultrasonic signal emitted by the speaker and the second ultrasonic signal received from an external device, and
the second time is received from the external device and is an elapsed time between receipt of the first ultrasonic signal at the external device and transmission of the second ultrasonic signal; and
calculate a distance between the apparatus and the external device based on the difference between the first time and the second time.

2. The apparatus of claim 1, wherein the circuitry is to calculate the first time from when the first ultrasonic signal is emitted by the speaker.

3. The apparatus of claim 1, wherein the circuitry is to calculate the first time from when the first ultrasonic signal is received by the microphone.

4. The apparatus of claim 1, wherein the speaker is a first speaker and the distance is a first distance, and further comprising a second speaker, and wherein the circuitry is to:
measure a time difference between a third time and a fourth time, where:
the third time is an elapsed time between transmission of a third ultrasonic signal by the apparatus and a receipt of a fourth ultrasonic signal by the microphone, the third ultrasonic signal emitted by the second speaker and the fourth ultrasonic signal received from an external device, and
the fourth time is received from the external device and is an elapsed time between receipt of the third ultrasonic signal at the external device and transmission of the fourth ultrasonic signal; and
calculate a second distance between the apparatus and the external device based on the difference between the third time and the fourth time.

5. The apparatus of claim 4, wherein the circuitry is to calculate:
a third distance between the apparatus and the external device based on the difference between the first time and the third time;
a fourth distance between the apparatus and the external device based on the difference between the second time and the third time;
a fifth distance between the apparatus and the external device based on the difference between the first time and the fourth time; and
a sixth distance between the apparatus and the external device based on the difference between the second time and the fourth time.

6. The apparatus of claim 4, wherein the circuitry is to calculate a rotation angle of the external device relative to the apparatus.

7. The apparatus of claim 6, wherein the microphone is one of a plurality of microphones equipped to the apparatus, and wherein the circuitry is to calculate the rotation angle based in part on a geometry of the plurality of microphones, and first and second speakers.

8. The apparatus of claim 1, wherein the apparatus receives the second time from the external device over a wireless transmission.

9. The apparatus of claim 1, wherein the apparatus receives the second time from the external device encoded in the second ultrasonic signal.

10. The apparatus of claim 1, wherein the second time is received as a first timestamp and a second timestamp from the external device, the first timestamp corresponding to receipt of the first ultrasonic signal at the external device and the second timestamp corresponding to transmission of the second ultrasonic signal, and the circuitry is to compute the second time from the first timestamp and second timestamp.

11. The apparatus of claim 1, wherein the apparatus is a laptop computer or mobile computing device.

12. A method, comprising:
transmitting, from an apparatus, a first ultrasonic signal;
receiving, at the apparatus, a second ultrasonic signal from a remote device;
calculating, by the apparatus, a first time from transmission of the first ultrasonic signal to receipt of the second ultrasonic signal;
receiving, at the apparatus, a second time from the remote device that corresponds to a time between receipt of the first ultrasonic signal and transmission of the second ultrasonic signal; and
calculating, by the apparatus, a distance from the apparatus to the remote device from the first time and the second time.

13. The method of claim 12, wherein the second ultrasonic signal is received at a microphone equipped to the apparatus, and calculating the first time comprises calculating the time between receipt of the first ultrasonic signal at the microphone and receipt of the second ultrasonic signal.

14. The method of claim 12, wherein the first ultrasonic signal is transmitted from a speaker equipped to the apparatus, and calculating the first time comprises calculating the time between transmission of the first ultrasonic signal from the speaker and receipt of the second ultrasonic signal at a microphone equipped to the apparatus.

15. The method of claim 12, wherein receiving the second time from the remote device comprises receiving the second time over a wireless data link.

16. The method of claim 12, wherein receiving the second time from the remote device comprises receiving the second time as part of the second ultrasonic signal.

17. The method of claim 12, wherein the distance is a first distance, and comprising:
transmitting, from the apparatus, a third ultrasonic signal, the third ultrasonic signal transmitted from a location on the apparatus that is different than a location of transmission of the first ultrasonic signal;
receiving, at the apparatus, a fourth ultrasonic signal;
calculating, by the apparatus, a third time from transmission of the third ultrasonic signal to receipt of the fourth ultrasonic signal;
receiving, at the apparatus, a fourth time from the remote device that corresponds to a time between receipt of the third ultrasonic signal and transmission of the fourth ultrasonic signal;
calculating, at the apparatus, a second distance from the apparatus to the remote device from the third time and the fourth time; and
calculating, at the apparatus, an orientation of the remove device relative to the apparatus from at least the difference between the first distance and second distance, and geometry of the locations of transmission of the first and third ultrasonic signals.

18. A non-transitory computer-readable medium (CRM) comprising instructions that, when executed by a processor of an apparatus, cause the apparatus to:
transmit a first ultrasonic signal;
receive a second ultrasonic signal from a remote device;
calculate a first time from transmission of the first ultrasonic signal to receipt of the second ultrasonic signal;
receive a second time from the remote device that corresponds to a time between receipt of the first ultrasonic signal and transmission of the second ultrasonic signal; and
calculate a distance from the apparatus to the remote device from the first time and the second time.

19. The CRM of claim 18, wherein the instructions are to further cause the apparatus to:
transmit a third ultrasonic signal, the third ultrasonic signal transmitted from a location on the apparatus that is different than a location of transmission of the first ultrasonic signal;
receive a fourth ultrasonic signal;
calculate a third time from transmission of the third ultrasonic signal to receipt of the fourth ultrasonic signal;
receive a fourth time from the remote device that corresponds to a time between receipt of the third ultrasonic signal and transmission of the fourth ultrasonic signal;
calculate a second distance from the apparatus to the remote device from the third time and the fourth time; and
calculate an orientation of the remove device relative to the apparatus from at least the difference between the first distance and second distance, and geometry of the locations of transmission of the first and third ultrasonic signals.

20. The CRM of claim 19, wherein the instructions are to further cause the apparatus to:
receive a fifth signal from the remote device;
transmit a sixth signal;
calculate a fifth time from receipt of the fifth signal to transmission of the sixth signal; and
transmit the fifth time.

21. A method, comprising:
receiving, at an apparatus, an ultrasonic signal from a remote device at a first microphone;
receiving, at the apparatus, the ultrasonic signal from the remote device at a second microphone;
comparing, by the apparatus, a first timestamp of receipt of the ultrasonic signal at the first microphone with a second timestamp of receipt of the ultrasonic signal at the second microphone; and
determining, by the apparatus, a position of the remote device relative to the apparatus based on the first and second timestamps.

22. The method of claim 21, wherein the ultrasonic signal is a first ultrasonic signal, and further comprising:
transmitting, by the apparatus, a second ultrasonic signal;
receiving, at the apparatus, a first time from the remote device that corresponds to a time between receipt of the second ultrasonic signal at the remote device and transmission of the first ultrasonic signal by the remote device; and
calculating, by the apparatus, a distance from the apparatus to the remote device from the difference between the first timestamp and second timestamp, and the first time.

23. The method of claim 22, wherein the apparatus is a laptop or mobile device.
